(19) United States
(12) Patent Application Publication
(10) Pub. No.: US 2015/0076433 A1
(43) Pub. Date: Mar. 19, 2015

(54) MEANS FOR PROTECTING A FENCE LINE

(71) Applicant: JEREMY BRANDFORD, WAIMANA (NZ)

(72) Inventor: JEREMY BRANDFORD, WAIMANA (NZ)

(21) Appl. No.: 14/323,796

(22) Filed: Jul. 3, 2014

(30) Foreign Application Priority Data
Aug. 22, 2013 (NZ) 614628

(51) Int. Cl. A01K 3/00; E04H 17/06

(52) U.S. Cl. CPC A01K 3/005; E04H 17/06
USPC 256/10

(57) ABSTRACT

A fence line has a series of electrified wands extending outwards of the fence line at intervals. Each wand is arranged such that in the event a livestock animal walks along the fence line it will contact the wand and the wand will move in the direction the animal is moving so as not to break away from the fence line. At the same time the wand will deliver an electric shock to the animal to deter it from walking along the fence line subsequently. After delivering the shock, the wand moves to assume the disposition it had prior to contact with the animal.

### RELATED APPLICATIONS

The present utility patent application is related and claims priority from NZ patent application no. 614628 filed Aug. 22, 2013.

### BACKGROUND

In the context of farming it is known to use fence lines to keep livestock within a particular area. Typically such fence lines comprise a series of upright posts supporting wires running generally parallel to the ground. These are quite robust but over time they can be significantly weakened or damaged by contact with livestock. For example livestock may repeatedly walk along and brush against the fence line. Over time this can cause a furrow close to and along the fence line as well as damage to the wires generally. It is accordingly an object of a preferred form of the invention to go at least some way towards addressing this problem or to at least provide the public with a useful choice.

### SUMMARY OF THE INVENTION

According to one aspect of the invention there is provided a fence line having a series of electrified wands extending outwards at intervals, each wand arranged such that in the event a livestock animal walks along the fence line it will contact the wand and the wand will move in the direction the animal is moving so as not to break away from the fence line and will, at the same time, deliver an electric shock to the animal to deter it from walking along the fence line subsequently and, after delivering the shock, the wand will move to assume the disposition it had prior to contact with the animal.

Preferably each wand cantilevers from the fence line.

Preferably each wand is secured to a respective wire and a respective post of the fence line.

Preferably each wand has a diagonal brace extending to a respective post.

Preferably each wand has an electrical insulator sleeve and a metallic arm wherein the arm proceeds through the sleeve.

Preferably the metallic arm is coiled around the wire adjacent to a respective fence post.

Preferably each wand has sufficient strength to bend when pushed in the direction of the fence line and also has sufficient spring-back to automatically bend back to its original disposition when the pushing force is no longer present.

Preferably an outer end of each arm is curved to provide a protective eye.

Preferably each wand is generally horizontal with respect to the fence line.

Preferably the fence line comprises wires running generally parallel to a ground surface from which the fence line extends.

According to a further aspect of the invention there is provided a wand suitable for use with a fence line as set out above, the wand having a conductive arm, an insulator sleeve around part of the conductive arm, a diagonal brace attached to and extending from the sleeve and protective means (eg an eye) at the end of the arm adapted to protect against eye damage to livestock if they should contact the arm.

According to a further aspect of the invention there is provided a method of protecting a fence line comprising securing a plurality of wands as set out above to the fence line, wherein each conductive arm is connected to an electrified wire and each brace is fastened at one end to a respective post of the fence line, and electrifying each wand.

### DESCRIPTION OF THE DRAWINGS

Some preferred forms of the invention will now be described by way of example and with reference to the accompanying drawings, of which:

FIG. 1 is an isometric view of an electrified wand fitted to a fence line;

FIG. 2 is plan view of the fence line; and

FIG. 3 is plan view of two similar wands fitted to a fence post.

### DETAILED DESCRIPTION

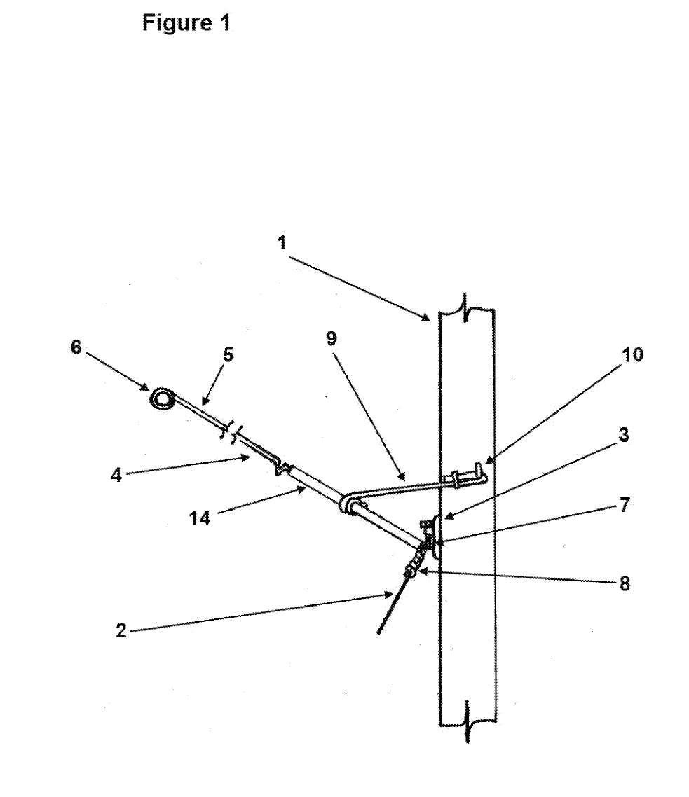

Referring to FIG. 1, a vertically disposed fence post 1 is set in the ground and supports series of parallel horizontal fencing wires 2. Only one of the wires is shown but it will be appreciated that other wires will be arranged similarly and run along a row of posts to present a barrier to deer on, for example, a deer farm. As shown, at least one of the wires 2 is secured to the posts 1 by way of electrical insulators 3.

With further reference to FIG. 1, an elevated wand 4 cantilevers outwards from the post 3. The wand 4 has a conductive metallic arm 5 which, at its distil end, is turned to provide an eye 6 and, at its opposite end 7, is coiled around and crimped 8 to the wire 2. The eye 6 serves to protect live stock from eye damage when they contact the wand. The wand has an insulator sleeve 8 and, as shown, the metallic arm 5 passes through this between its distil and inner ends.

As shown, the wand has an angle brace 9 which is secured to the sleeve 8 at one end and at its other end to the post 1 by way of staples 10 or any other suitable fixing means. The brace 9 assists in supporting the wand horizontally from the fence line. However the wand need not be strictly horizontal, and in some cases it may be angled upwards or downwards somewhat.

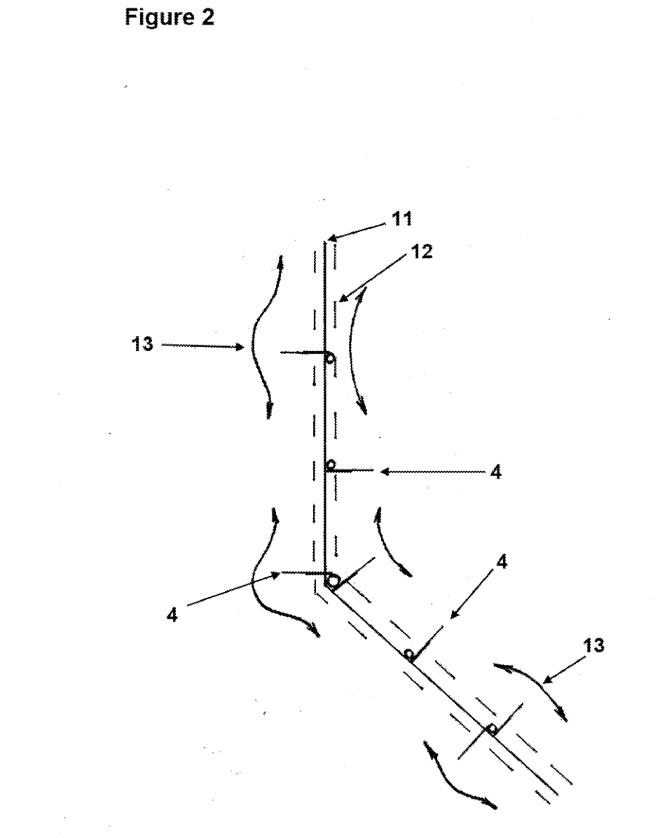

As illustrated in FIG. 2, a plurality of the wands 4 are arranged similarly along a fence line 11 at intervals. The arrangement is such that in the event a deer walks along the fence line 11 and brushes against a wand 4 the wand bends in the direction the animal is moving and then springs back to its original disposition when the animal has passed. The wire 2 is electrified and delivers electricity to the metallic arm 5 of each wand. Therefore when a deer contacts a wand it is given an electric shock. Over time the animal learns not to walk closely along the fence line so as to avoid being shocked. Only one wire of the fence need be electrified to deliver power to each wand, although if desired more than one wire may be electrified.

The dotted lines 12 illustrate the typical course taken along a fence line by a deer if there are no wands 4 present. The curved arrows 13 illustrate the sort of course a deer will take once it as learned to keep its distance to avoid the discomfort or pain of an electric shock. The wands therefore teach deer to avoid the fence line and in this way fence line is protected from damage due to animal contact. It also prevents undesirable hoof traffic furrows forming close along the fence line.

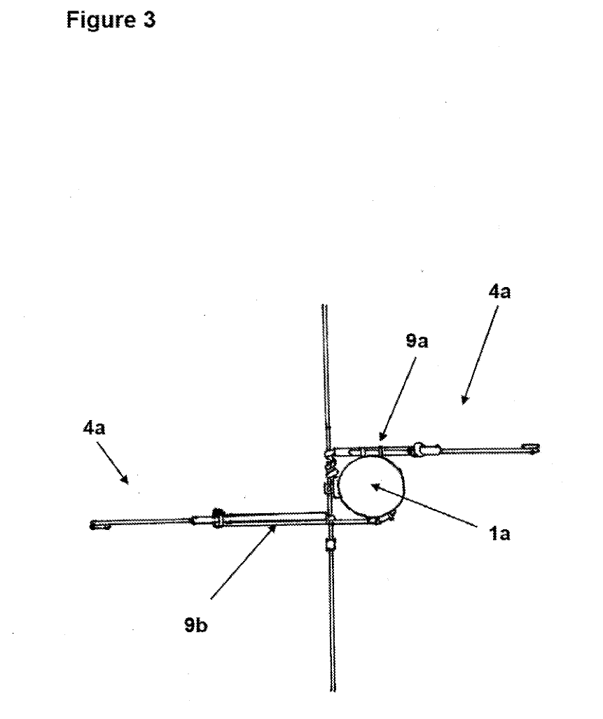

FIG. 3 illustrates a post 1 a when fitted with two wands 4a, one of which has a short angle bracket 9a and the other of which has a medium length angle bracket 9b.

Although the invention has been described in the context of deer farming it should be appreciated that it can also be used similarly for farming or keeping other live stock, for example sheep, cattle or horses, etc. The height of the wands will be set depending on the type of livestock they are used with.

In some alternative forms of the invention the post may simply be a batten of the fence line, for example the post need not be actually set in the ground. The term “post” as used in this document should therefore be interpreted to encompass this.

While some preferred aspects of the invention have been described by way of example, it should be appreciated that modifications and improvements can occur without departing from the scope of the following claims.

1. A fence line having a series of electrified wands extending outwards at intervals, each wand arranged such that in the event a livestock animal walks along the fence line it will contact the wand and the wand will move in the direction the animal is moving so as not to break away from the fence line and will, at the same time, deliver an electric shock to the animal to deter it from walking along the fence line subsequently and, after delivering the shock, the wand will move to assume the disposition it had prior to contact with the animal.

2. A fence line according to claim 1, wherein each wand cantilevers from the fence line.

3. A fence line according to claim 1, wherein each wand cantilevers and is secured to a respective wire and a respective post of the fence line.

4. A fence line according to claim 1, wherein each wand cantilevers and is secured to a respective wire and a respective post of the fence line, and wherein each wand has a diagonal brace extending to a respective post.

5. A fence line according to claim 1, wherein each wand cantilevers and is secured to a respective wire and a respective post of the fence line, each wand has a diagonal brace extending to a respective post, and each wand has an electrical insulator sleeve and a metallic arm wherein the arm proceeds through the sleeve.

6. A fence line according to claim 5, wherein each metallic arm is coiled around the wire at a position adjacent to a respective fence post.

7. A fence line according to claim 1, wherein each wand cantilevers and is secured to a respective wire and a respective post of the fence line, each wand has a diagonal brace extending to a respective post, and wherein each wand has sufficient strength to bend when pushed in the direction of the fence line and also has sufficient spring-back to automatically bend back to its original disposition when the pushing force is no longer present.

8. A fence line according to claim 1, wherein an outer end of each arm is curved to provide a protective eye.

9. A fence line according to claim 1, wherein each wand is generally horizontal with respect to the fence line.

10. A fence line according to claim 1, comprising wires running generally parallel to a ground surface from which the fence line extends.

11. A wand formed so as to be suitable for use with a fence line according to claim 1, the wand having a conductive arm, an insulator sleeve around part of the conductive arm, a diagonal brace attached to and extending from the sleeve, and protective means at an end of the arm adapted to protect against eye damage to livestock if they should contact the arm.

12. A wand according to claim 11, wherein the brace extends outwardly from around the sleeve.

13. A wand according to claim 11, wherein the brace extends outwardly from around the sleeve and the arm is metallic.

14. A wand according to claim 11, wherein an opposite end of the arm extends beyond the sleeve and is formed so it is be able to be coiled around a fence wire to assist in securing the wand to such wire when the wand is in use.

15. A wand according to claim 11, formed such that it can be arranged with the wand extending outwards of a fence line so that in the event a livestock animal walks along the fence line it will contact the wand and the wand will move with the animal so as not to break away from the fence line, and at the same time, delivers an electric shock to the animal to deter it from walking along the fence line subsequently and such that, after delivering the shock, the wand will move to assume the disposition it had prior to contact with the animal

16. A method of protecting a fence line comprising securing a plurality of wands as set out in claim 11 to the fence line, wherein each conductive arm is connected to an electrified wire and each brace is fastened at one end to a respective post of the fence line, and electrifying each wand.
